(19) United States
(12) Patent Application Publication
(10) Pub. No.: US 2016/0267700 A1
(43) Pub. Date: Sep. 15, 2016

(54) Generating Motion Data Stories

(71) Applicant: Microsoft Technology Licensing, LLC, Redmond, WA (US)

(72) Inventors: He Huang, Beijing (CN); Haidong Zhang, Beijing (CN); Zhitao Hou, Beijing (CN); Dongmei Zhang, Bellevue, WA (US); Song Ge, Beijing (CN)

(21) Appl. No.: 14/643,987

(22) Filed: Mar. 10, 2015

(51) Int. Cl. G06T 13/80; G06F 17/27; G06F 17/24; G06T 11/60; G06F 3/0484

(52) U.S. Cl. CPC G06T 13/80; G06T 11/60; G06F 3/04845; G06F 3/04842; G06F 17/24; G06F 17/2785

(57) ABSTRACT

Techniques and arrangements for creating and editing motion data stories are described herein. In some implementations, the techniques and arrangements may determine semantic differences between consecutive slides intended to be used as the basis for a motion data story, and use the determined differences to determine appropriate transitional animations and/or animation effects. In addition to determined semantic differences, templates may also be used to determine the transitional animations and/or animation effects.

### BACKGROUND

Graphical representations, such as charts, graphs, and the like, are conventionally used to present data. In some implementations, the representations may be arranged on slides, as part of a slide show. The slide show may be used as a visual aid in support of an oral presentation. In association with the presentation, copies of the slides, e.g., paper copies or digital copies, may be provided to an intended audience of the presentation. The audience may use such copies to follow along with the oral presentation, for future reference, or for some other use. In other scenarios, a slide deck of graphical representations may be intended to act alone, for example, as a document without an accompanying presentation.

Presenting material using a slide deck may be problematic, particularly to the audience. For example, excessive slide text may disengage the audience from the presentation, with the audience opting to read the slides instead of listen to the orator. Moreover, abrupt transitions from one slide to another may result in a loss of context or fail to make a relationship between slides explicit. In some instances an adept orator may provide a verbal linkage between slides, but even in those instances, the copies of the slide deck will not include that linkage.

### SUMMARY

This summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Some implementations of this disclosure provide techniques and arrangements for displaying a user interface that allows a user to create a motion data story. In some examples, a user uploads or otherwise selects a plurality of graphical depictions of data for inclusion in a motion data story. The depictions may be displayed to the user as slides, and the user may add, remove, and/or re-order the slides. The techniques and arrangements determine semantic differences between consecutive slides, and use those differences to determine a transitional animation for transitioning, in a video, between the consecutive slides.

In some implementations, the techniques and arrangements may associate animation effects and/or additional content with portions of the graphical depictions in the slides. In some cases, the effects and/or additional content annotate or highlight interesting data.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items or features.

FIG. 1 is a schematic diagram of an illustrative computing environment for implementing various embodiments of motion data story generation.

FIG. 2 is a schematic diagram of illustrative components in an example device in which some implementations of this disclosure may operate.

FIGS. 3-6 illustrate views of an example user interface for creating and/or editing motion data stories according to some implementations of this disclosure.

FIGS. 7-12 illustrate sequential frames of an example presentation of a motion data story created and/or edited in the example user interface of FIGS. 3-5, according to some implementations of this disclosure.

FIG. 13 illustrates an example process flow for creating and/or editing motion data stories, according to some implementations of this disclosure.

### DETAILED DESCRIPTION

### Overview

As discussed above, data has conventionally been presented on presentation slides as a visual aid to an oral narrative. More recently, motion graphics or motion data stories have been used to convey data and information about that data. As used herein, a motion data story generally refers to a video that includes animations, narration, and/or other effects to tell a story about data. The term “video” is used herein generally to refer to any non-format-specific moving visual, and may also include audio.

Motion data stories provide an enhanced means for telling stories. Motion data stories may be intuitive, vivid and engaging, and therefore preferential to static slide-shows. However, creating motion data stories is difficult and expensive, primarily because of the difficulty in creating proper and impressive animation effects. In some instances, the creator of a motion data story may need special training in video editing software and/or techniques and in still other instances, the creator may need programming experience.

The present disclosure describes techniques and arrangements for creating and editing motion data stories, which may improve audience comprehension of sometimes complex graphical representations of data. The techniques described herein enable users to easily create attractive motion data stories to convey information, without requiring extensive video editing and/or programming understanding and experience.

For example, a user may accumulate or collect data about some topic or topics, and desire to share that data in a video. The focal point of the story may be a series of graphical representation or depictions, e.g., charts and/or graphs, that represent the data. In some implementations, the user may generate or otherwise acquire the graphical representations, and the graphical representations may be contained on one or more slides. In implementations, the user may arrange the graphical representations, or slides containing the graphical representations, in an order of presentation. The user may also edit the slides or attributes of the slides, for example, using an interface.

In various embodiments, consecutive slides are compared, and semantic differences between the compared slides are discerned automatically. For example, techniques described herein may compare data files associated with two consecutive charts to determine the semantic differences. In some embodiments, a taxonomy of semantic difference types may be determined, and the semantic differences module may identify differences between compared slides within that taxonomy. The semantic differences may be used to determine an appropriate transitional animation for transitioning between the consecutive slides. A video is then created that uses the determined transitional animation to transition between the consecutive slides.

Methods of generating motion data stories as described herein may be far simpler and less time consuming than previous solutions. The methods described herein may minimize user input, by automatically identifying semantic differences between consecutive slides and determining transitional animations and/or animation effects based on those differences. Moreover, the methods described herein may obviate the need for specific knowledge and/or understanding of specialized design software and/or programming techniques. As a result, such methods enable the user to generate pleasing, engaging, and informative motion data stories relatively quickly, thereby facilitating the use of such motion data stories as an efficient means of data communication. Additionally, methods described herein may enable users to create motion data stories in ways not possible using existing systems.

Illustrative environments, devices, and techniques for generating motion data stories are described below. However, the described motion data story generation techniques may be implemented in other environments and by other devices or techniques, and this disclosure should not interpreted as being limited to the example environments, devices, and techniques described herein.

### Illustrative Architecture

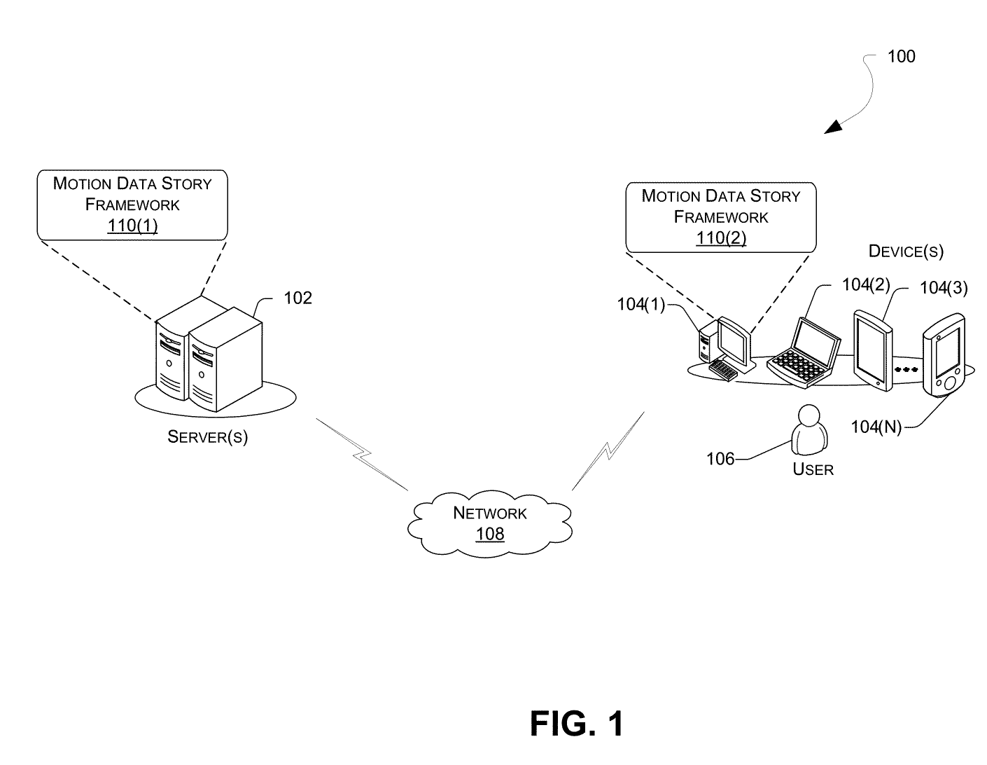

FIG. 1 is a schematic diagram of an illustrative computing environment 100 for implementing various embodiments of generating and editing motion data stories. The computing environment 100 may include one or more server(s) 102 and one or more electronic device(s) 104(1)-104(N) (collectively “electronic devices 104”) operable by users 106, such as users creating a motion data story. The server(s) 102 and the electronic devices 104 are communicatively connected by one or more networks 108.

FIG. 1 also illustrates a motion data story framework 110-1 associated with the server(s) 102 and a motion data story framework 110-2 associated with the devices 104. Although two motion data story frameworks 110-1, 110-2 are illustrated, i.e., one associated with each of the server(s) 102 and the electronic devices 104, this is merely representative. In some implementations, the motion data story framework may be implemented at a single location, e.g., as software or code running on a stand-alone computer, which may be one of the devices 104 or some other device. In other implementations, the motion data story framework may be implemented at a location other than on the user device, e.g., on the server(s) 102, which may be local or remote server(s), or a combination thereof. In still other implementations, the motion data story framework may be implemented across multiple devices, including the server(s) 102 and one or more of the electronic devices 104. In one implementation, the framework may be embodied as software hosted locally, e.g., on a client server or device, although it may alternatively be hosted on remote servers, such as in a Software as a Service (SaaS) model. Other implementations may also be appreciated by those having ordinary skill in the art. For clarity throughout the remainder of this disclosure, reference will be made to the motion data story framework 110, which may be embodied in a number of different ways, included those illustrated and described above.

The electronic device 104 may be implemented as any of a variety of conventional computing devices including, for example, a desktop computer 104(1), a notebook or portable computer 104(2), a handheld device 104(3), 104(N), a netbook, an Internet appliance, a portable reading device, an electronic book reader device, a tablet or slate computer, a game console, a mobile device (e.g., a mobile phone, a personal digital assistant, a smart phone, etc.), a media player, etc. or a combination thereof.

The network(s) 108 can include public networks such as the Internet, private networks such as an institutional and/or personal intranet, or some combination of private and public networks. The network(s) 108 can also include any type of wired and/or wireless network, including but not limited to local area networks (LANs), wide area networks (WANs), satellite networks, cable networks, Wi-Fi networks, WiMax networks, mobile communications networks (e.g., 3G, 4G, and so forth) or any combination thereof. The network(s) 104 can utilize communications protocols, including packet-based and/or datagram-based protocols such as internet protocol (IP), transmission control protocol (TCP), user datagram protocol (UDP), or other types of protocols. Moreover, the network(s) 108 can also include a number of devices that facilitate network communications and/or form a hardware basis for the networks, such as switches, routers, gateways, access points, firewalls, base stations, repeaters, backbone devices, and the like.

In some examples, the network(s) 108 can further include devices that enable connection to a wireless network, such as a wireless access point (WAP). The network(s) may support connectivity through WAPs that send and receive data over various electromagnetic frequencies (e.g., radio frequencies), including WAPs that support Institute of Electrical and Electronics Engineers (IEEE) 802.11 standards (e.g., 802.11g, 802.11n, and so forth), and other standards.

### Example Servers

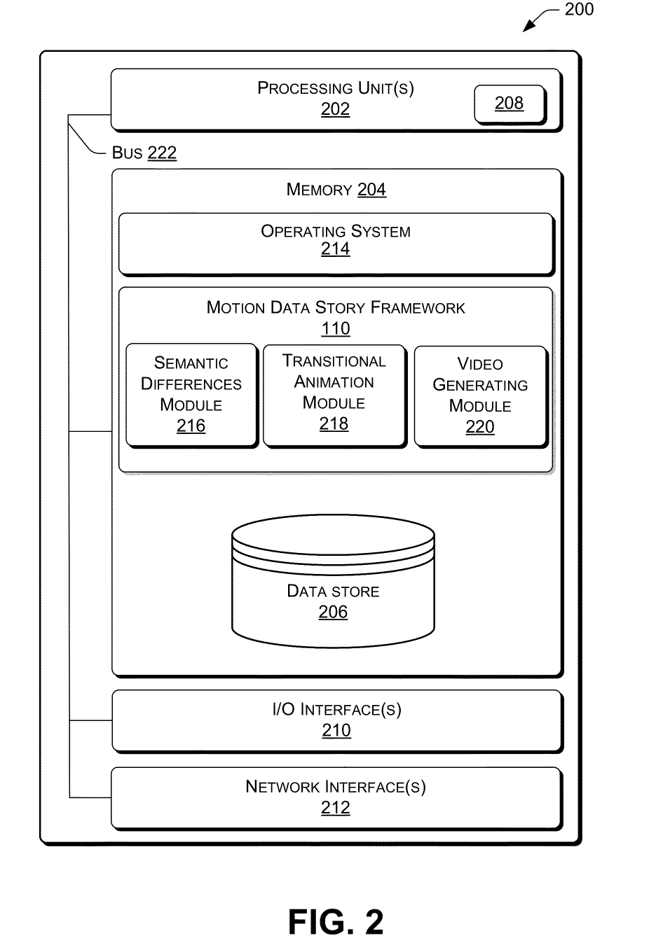

FIG. 2 is a block diagram depicting an example computing device 200 which may be the server(s) 102 and/or the electronic device(s) 104 for implementing the motion data story framework. The illustrated device 200 includes one or more processing unit(s) 202 coupled to memory 204.

The one or more processing unit(s) 202 can represent, for example, a central processing unit (CPU), a graphics processing unit (GPU), a field programmable gate array (FPGA), another class of digital signal processor (DSP), or other hardware logic components that can, in some instances, be driven by a CPU. For example, and without limitation, illustrative types of hardware logic components that can be used include application-specific integrated circuits (ASICs), application-specific standard products (ASSPs), system-on-a-chip systems (SOCs), complex programmable logic devices (CPLDs), etc.

The processing unit(s) 202 are configured to execute instructions received from a network interface 212, received from an input/output interface 210, and/or stored in the memory 204.

The memory 204 includes tangible and/or physical forms of media included in a device and/or hardware component that is part of a device or external to a device, including but not limited to random-access memory (RAM), static random-access memory (SRAM), dynamic random-access memory (DRAM), read-only memory (ROM), erasable programmable read-only memory (EPROM), electrically erasable programmable read-only memory (EEPROM), phase change memory (PRAM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

Although the memory 204 is depicted in FIG. 2 as a single unit, the memory 204 (and all other memory described herein) may include computer storage media or a combination of computer storage media and other computer-readable media. Computer-readable media may include computer storage media and/or communication media. Computer storage media includes volatile and non-volatile, removable and non-removable media implemented in any method or technology for storage of information such as computer-readable instructions, data structures, program modules, or other data. Computer storage media includes, but is not limited to, PRAM, SRAM, DRAM, other types of RAM, ROM, EEPROM, flash memory or other memory technology, CD-ROM, DVD or other optical storage, magnetic cassettes, magnetic tape, magnetic disk storage or other magnetic storage devices, or any other non-transmission medium that can be used to store information for access by a computing device.

In contrast, communication media may embody computer-readable instructions, data structures, program modules, or other data in a modulated data signal, such as a carrier wave, or other transmission mechanism. As defined herein, computer storage media does not include communication media.

In the illustrated example, the memory 204 also includes a data store 206. In some examples, the data store 206 includes data storage such as a database, data warehouse, or other type of structured or unstructured data storage. In some examples, the data store 206 includes a corpus and/or a relational database with one or more tables, indices, stored procedures, and so forth to enable data access including one or more of hypertext markup language (HTML) tables, resource description framework (RDF) tables, web ontology language (OWL) tables, and/or extensible markup language (XML) tables, for example. The data store 206 can store data for the operations of processes, applications, components, and/or modules stored in computer-readable media 204 and/or executed by processing unit(s) 202 and/or accelerator(s). In some implementations, the data store 206 can store graphical depictions of data, such as charts and graphs, data represented by or associated with such graphical depictions, a taxonomy of semantic differences, information about transitional animations, or other information that can be used to aid in creating motion data stories. Some or all of the above-referenced data can be stored on separate memories 208 on board one or more processing unit(s) 202 such as a memory on board a CPU-type processor, a GPU-type processor, an FPGA-type accelerator, a DSP-type accelerator, and/or another accelerator. In other implementations, some or all of the above-referenced data may be stored on memories remote from the device 200.

As noted above, the device 200 may further include one or more input/output (I/O) interfaces 210 to allow the device 200 to communicate with input/output devices such as user input devices including peripheral input devices (e.g., a keyboard, a mouse, a pen, a game controller, a voice input device, a touch input device, a gestural input device, and the like) and/or output devices including peripheral output devices (e.g., a display, a printer, audio speakers, a haptic output, and the like). In addition, in the device 200, the one or more network interface(s) 212 facilitate transmission of communication over a network, such as the network 108. For example, the network interface(s) 212 can represent network interface controllers (NICs) or other types of transceiver devices to send and receive communications over a network.

In the illustrated example, the memory 204 includes an operating system 214. The memory 204 also includes the motion data story framework 110. The memory 204 may be configured to store one or more software and/or firmware modules, which are executable on the one or more processing unit(s) 202 to implement various functions of the motion data story framework. The term “module” is intended to represent example divisions of the software for purposes of discussion, and is not intended to represent any type of requirement or required method, manner or organization. Accordingly, while modules 216, 218, 220 are illustrated and discussed below, their functionality and/or similar functionality could be arranged differently. For example, functionality described associated with the blocks 216, 218, 220 can be combined to be performed by a fewer number of modules or it can be split and performed by a larger number of modules.

In the illustration, block 216 represents a semantic differences module with logic to program the processing unit(s) 202 to determine semantic differences between graphical representations, which may be contained on slides. The content of the slides, e.g., the graphical representations on the slides, as well as the slides themselves, may be generated in the context of the motion data story framework or they may be acquired at the framework, such as by a user selecting the graphical representations and/or slides or otherwise importing the graphical representations and/or slides. In some embodiments of this disclosure each of the slides includes a graphical representation of data. For each of the slides, the semantic differences module 216 may consider any measurable or otherwise identifiable feature or attribute of the graphical depiction on the slide or data represented by the graphical depiction. Examples of such features or attributes may include information about the data graphically depicted in the charts (e.g., a value of the data points) or information about the charts (e.g., categories of data in the chart). Information about the charts may also be contained in one or more chart models, examples of which are described below in more detail, and the semantic differences module may discern differences between models associated with consecutive charts. In still other examples, attributes may include spatial locations of graphical depictions or of portions of graphical depictions (e.g., portions of a chart or graph corresponding to one or more specific data points) or types of the graphical depiction (e.g., whether the graphical depiction is a bar chart, a line chart, a column chart, a histogram, etc.). Based on the features and attributes, the semantic differences module determines one or more differences between consecutive slides.

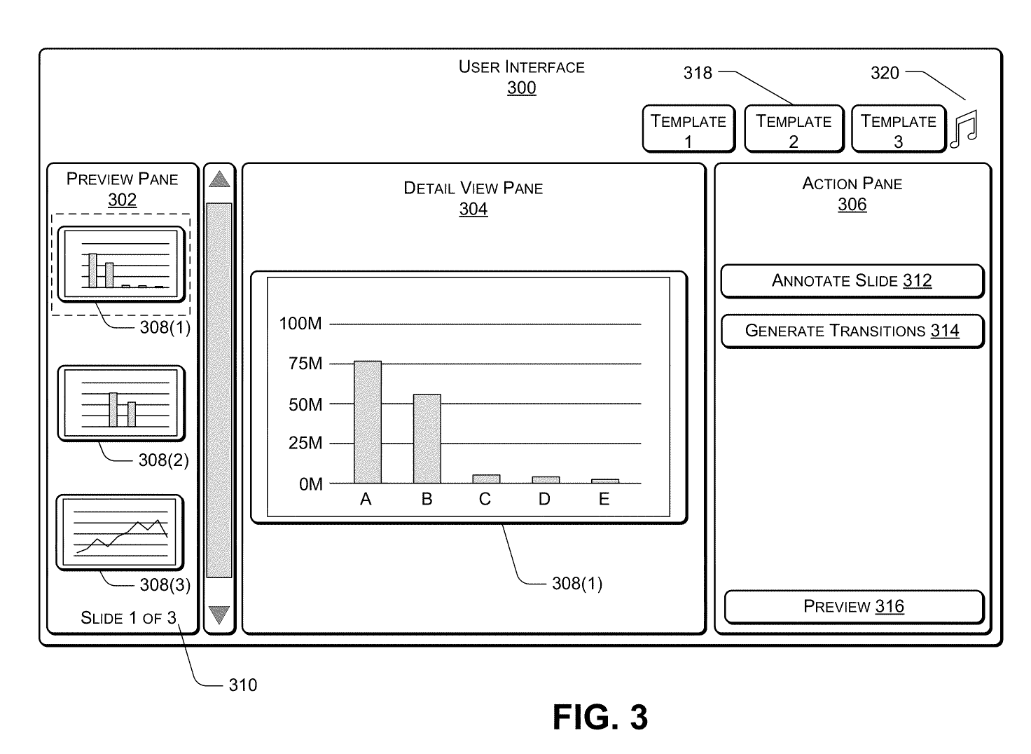

By way of example, FIG. 3, which will be described in more detail below, shows a first slide 308(1) and a second slide 308(2), and the semantic differences module 216 will determine semantic differences between these slides. For example, the semantic differences module 216 may determine that the graphical representations in those slides differ in that bars associated with entities C, D, and E (and the axial identification of the entities C, D, and E) in the first slide 308(1) are omitted from the second slide 308(2). Thus, the data set represented by the bar graph of the first slide 308(1) includes more data than the data set represented by the bar graph of the second slide 308(2). In the same example, the semantic differences module 216 may determine that, although the values of the data associated with entities A and B remain the same from the first slide 308(1) to the second slide 308(2), the relative position of the graphical representations of that data changes. Specifically, the bars associated with entities A and B (and the corresponding identifications of entities A and B) move closer to the center of the second slide 308(2), that is, horizontally away from the y-axis.

In automatically determining the semantic differences, the semantic differences module 216 may compare chart data models representing the graphical depiction(s) on each of adjacent slides. A sample chart data model is provided for illustration as Table 1:

TABLE 1
Chart Data Model

| | | |
|---|---|---|
| 2011 | 2012 | 2013 |

| | |
|---|---|
| Entity A | Sales |
| | Profits |
| Entity B | Sales |
| | Profits |
| Entity C | Sales |
| | Profits |

Table 1 shows sales and profits information for three entities, namely, Entity A, Entity B, and Entity C (which may or not be the entities of FIG. 3) for each of three years, namely, 2011, 2012, and 2013. In this example chart data model, the Entities may be referred to as a Series Group and may be represented as {Brand: Entity A, Brand: Entity B, Brand: Entity C}, the Sales and Profits may be referred to as Value Groups and may be represented as {Sales, Profit}, and the Years may be referred to as Category Groups and may be represented as {Year: 2011, Year: 2012, Year: 2013}. More generally, the Series Group and the Category Group in this example are a set of values of a particular dimension (or a combination of multiple dimensions) and the Value Group contains one or more measures. As should be appreciated, the blank cells in the bottom-right portion (i.e., the cells populating the rows and columns of the chart) of Table 1 will be populated with data points to be plotted in a chart or graph.

The data model of Table 1 may be used as a generic representation of data for use by different chart types. Each chart type may plot the same data in different ways. For example, a line chart of Table 1 may arrange the categories {2011, 2012, 2013} as points along the x-axis, one of the measures, e.g., {Sales} or {Profits}, as values along the y-axis, and three series plots, referencing each of the three Series {Entity A, Entity B, Entity C}. Other orientations of the same data in the data model will be appreciated by those having ordinary skill in the art with the benefit of this disclosure.

In the example discussed above with reference to FIG. 3, a chart data model like the one illustrated in Table 1 may be associated with each of the first slide 308(1) and the second slide 308(2). For example, a chart data model associated with the first slide 308(1) will include Entities A and B in the Series Group, “Sales” as a Value Group, and a year or some other time as a single Category Group. A similar chart data model associated with the second slide 308(2) will include all the same information, but include Entities C, D, and E in the Series Group.

The semantic differences module 216 may further classify any differences it determines. For example, in one implementation of the framework, a taxonomy of semantic difference types may be determined, and the semantic differences module 216 may identify differences within that taxonomy. Using the examples of the first and second slides 308(1), 308(2) for illustration, and the chart data models just described, the semantic differences module 216 may identify the inter-slide removal of data relative to entities C, D, and E. The removal may be classified as a SeriesRemove, for example, in a taxonomy. Moreover, the semantic differences module 216 may also identify the movement of the bars corresponding to entities A and B along the x-axis from slide-to-slide. An example taxonomy may include semantic differences that correspond to commands such as VisualChange (which may correspond to a change in type of chart or graph displayed or a change in some visual characteristic of that chart or graph), ValueChange (a change in a value of a data point), OrderingChange (re-ordering of data), SeriesAdd (adding a series of data), SeriesRemove (removing a series of data), CategoryAdd (adding a category of data), CategoryRemove (removing a category of data), MeasureAdd (adding a measure, such as Sales or Profits, e.g., to a Value Group), MeasureRemove (removing a measure, such as Sales or Profits, e.g., to a Value Group), GroupMerge (a merge of two or more groups of data), GroupSplit (a separation of data into two or more groups), and/or AxisTypeChange (a change in the scale or appearance of an axis). The taxonomy may include additional or alternative commands to identify additional semantic differences, as well.

Returning to FIG. 2, the computer-readable media may also store a transitional animation module 218 with logic to program the processing unit 202 of the device 200 to determine a transitional animation for transitioning between consecutive slides. In some examples, a database or other memory stores a correspondence of transitional animations to semantic difference types. For example, each classification in the taxonomy described above may correspond to one or more transitional animations, and the transitional animation module may use the classification determined by the semantic differences module 218 to identify such corresponding transitional animation(s). In some implementations, the transitional animations may be stored as a set of rules, procedures, and/or animation effects used to animate a visual change between consecutive slides, thereby illustrating the semantic difference. The transitional animation module 218 may also generate the appropriate animation, for example, by executing the rules, procedures, and/or animation effects.

Any and all transitional animations that are effective at graphically representing a given taxonomy classification may be associated with that classification. For example, any transitional animation that graphically shows the addition of a new series of data between two consecutive charts can be associated with the SeriesAdd classification. Any transitional animation that graphically shows the deletion of a series of data between two consecutive charts can be associated with a SeriesRemove classification, and so forth. By way of non-limiting example, the semantic differences module 218 may determine that the difference between consecutive slides is that a new series of data has been removed, or a SeriesRemove in the taxonomy, as described above with reference to FIG. 3. The semantic differences module may store a transitional animation that results in fading out the data corresponding to the removed series, and repositioning (such as centering) the remaining data. One or more other transitional animations may also or alternatively be associated with the same SeriesRemove classification in the taxonomy. For example, in one animation, the data to be removed could be removed other than by fading out. A graphical representation of that data could appear to be moved out of the frame of the display, for instance.

Similarly, one or more transitional animations may be associated with other or all of the classifications in the taxonomy. As another non-limiting example, the first slide 308(1) may be used to illustrate the Sales information from Table 1 above, but not profits. In this example, the second slide 308(2) in FIG. 3 may be replaced with a bar chart that graphically depicts all of the information from Table 1, i.e., both sales and profits. In one example, the profits may be added as a new bar for each entity, such that the replacement second slide includes ten bars (two associated with each entity, one for sales and one for profits), instead of five. In this example, the semantic differences module 218 determines a MeasureAdd between the first slide 308(1) and the replacement second slide. A transitional animation associated with MeasureAdd may slide the five bars already on the graph along the x-axis, to separate the existing bars, and the new bars, i.e., representing the profits data, may appear by “growing,” or extending upwardly in the y-direction, from the x-axis. Alternatively, the new bars could fade in. Other transitional animations, including modifications to those just described, will be appreciated by those having ordinary skill in the art with the benefit of the teachings of this disclosure.

In addition to using semantic differences to determine and/or generate a transitional animation, the transitional animation module 218 may also consider additional criteria. For example, as noted above, more than one transitional animation may correspond to a single classification in the taxonomy. One of transitional animations may be chosen based on a previous user selection, or preferences of a current user. Moreover, transitional animations may be themed, such as to correspond to a “look and feel” of a presentation. The “look and feel” may include such elements as colors, shapes, layout and typefaces, as well as the behavior of dynamic elements, such as using common movements or visual graphics to make transitions, add or remove text or other features, and the like. A user may specify a desired “look and feel,” for example, by selecting a template. Templates and information associated with those templates may be stored in a template repository or database, which may be included in the data store 206. In some implementations, a template may determine static characteristics, such as a color scheme, a font, and the like, as in conventional slide-generating, presentation applications. The template may also or alternatively determine dynamic characteristics, such as types of visual transitions, a duration or timing of visual transitions, and the like. Thus, for example, when multiple transitional animations could be used to show a change, the template may pre-select which transitional animation will be the default. For instance, a template may determine that any time information is removed during the course of a motion data story made according to aspects of this disclosure, the graphical representation of that information fades out from view, as opposed to moving out of view, or being removed via some other mechanism. These and other characteristics may also be manually selectable and/or adjustable.

The computer-readable media may also store a video generating module 220 with logic to program the processing unit 202 of the device 200 to generate the motion data story as a video. For example, the video generating module 220 may compile the slides, the transitional animations, as well as any additional content to create the motion data story. Such additional content may include annotations, such as textual annotations, animation effects, such as intra-slide animation effects, audio files, such as a soundtrack and/or voice overs, and the like.

In some implementations, the semantic differences may also be used to generate animation effects apart from the transitional animations. For example, when a transitional animation is to be tied to a specific segment or portion of a graphical depiction, an animation effect may first be applied to that segment or portion, before the transitional animation. For instance, when a determined transitional animation is a zoom to a specific portion of a chart or graph, e.g., a data point or a bar in the chart of graph, that specific portion may be highlighted or annotated automatically, as a basis of the determination of the semantic differences.

A bus 222 can include one or more of a system bus, a data bus, an address bus, a PCI bus, a Mini-PCI bus, and any variety of local, peripheral, and/or independent buses, and may operably connect the computer-readable media 204 to the processing unit(s) 202.

### Example Implementations

FIGS. 3-6 illustrate examples of a user interface 300 that may be displayed via a computing device (e.g., on a display of the electronic device 104) and examples of user interaction with the user interface 300. Implementations of the user interface 300 allow a user to create and edit motion data stories.

FIG. 3 illustrates an example of the user interface 300 according to some implementations. In the example of FIG. 3, the user interface 300 includes a storyline pane 302, a detail view pane 304, and an action pane 306.

The storyline pane 302 includes slides to be included in a motion data story. In the Example of FIG. 3, the slides include a first slide 308(1), a second slide 308(2), and a third slide 308(3) (collectively, slides 308). Of course, more or fewer slides may be included. In embodiments of this disclosure, each of the slides 308 contains a graphical representation of data. For example, the first slide 308(1) contains a bar chart showing sales (in M) for different entities A-F. The second slide 308(2) also includes a bar chart showing sales (in M), but only for entities A and B. The third slide 308(3) shows a line chart, which may further illustrate sales for entity A or B over some time period, e.g., quarterly or monthly. Although bar charts and line charts are illustrated in the Example of FIGS. 3-6, the slides may include any graphical representation of data. Such graphical representations may include other charts and/or graphs, including but not limited to horizontal bar charts, pie charts, scatter plots, box plots, pictographs, histograms, and so forth.

In some implementations, the storyline pane 302 allows the user to “author” the story to be told using motion graphics. More specifically, the storyline pane 302 may support adding new slides, e.g., to allow the user to include additional information in the story, removing slides, and/or reordering existing slides, e.g., to allow the user to alter the flow of the story. For example, new slides may be added using an “add slide” function and/or existing slides may be removed using a “remove slide” function. The functions may be accessible via a menu or the like. In other implementations, slides may be included using a conventional functionality such as “drag and drop” from a separate or integrated application, such as a business intelligence (BI) application or program. Similarly, a user may reorder the slides using any conventional method.

In the illustrated storyline pane 302, a dashed line is shown around the first slide 308(1) to indicate that the first slide 308(1) is the slide currently displayed in the detail view pane 104. It will be appreciated that alternative methods of identifying the currently displayed slide (e.g., using a different color, highlighting, size, etc.) may alternatively or additionally be used. Furthermore, in some cases, an indication 310 of the currently displayed slide (e.g., “Slide 1 of 3”) may be included to assist the user in identifying the current location in the presentation. Although illustrated in the storyline pane 302, the indication 310 may be in a different location in the user interface 300. In some implementations, each of the slides 308 in the storyline pane 302 may include thumbnail images of the graphical representations, instead of the complete representation.

The detail view pane 304 may include all details of a selected slide, here the first slide 308(1). A user may interact with the slide in the detail view pane, for example, by selecting features or portions of the slide. In some implementations, double-clicking on text in the slide in the detail view pane may open a text editing tool that allows the user to edit the selected text. Moreover, as will be discussed below, selecting one or more data points in the detail view pane 304 may open an annotation box that allows a user to, among other things, annotate, or otherwise highlight, the selected data points.

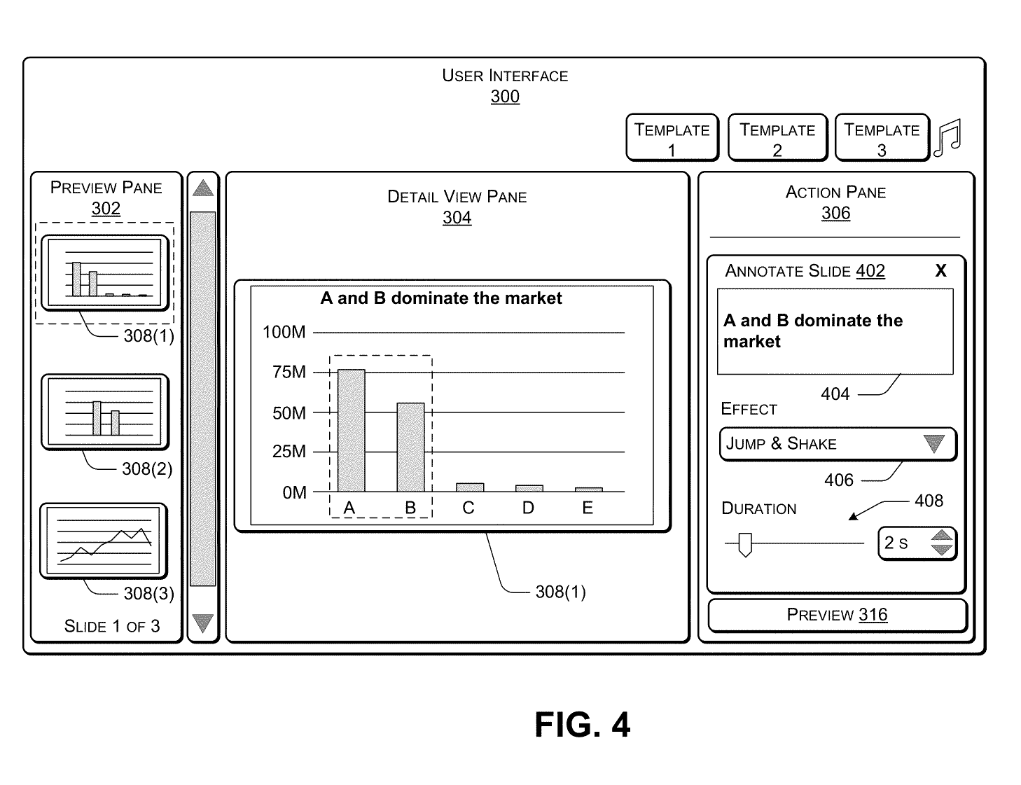

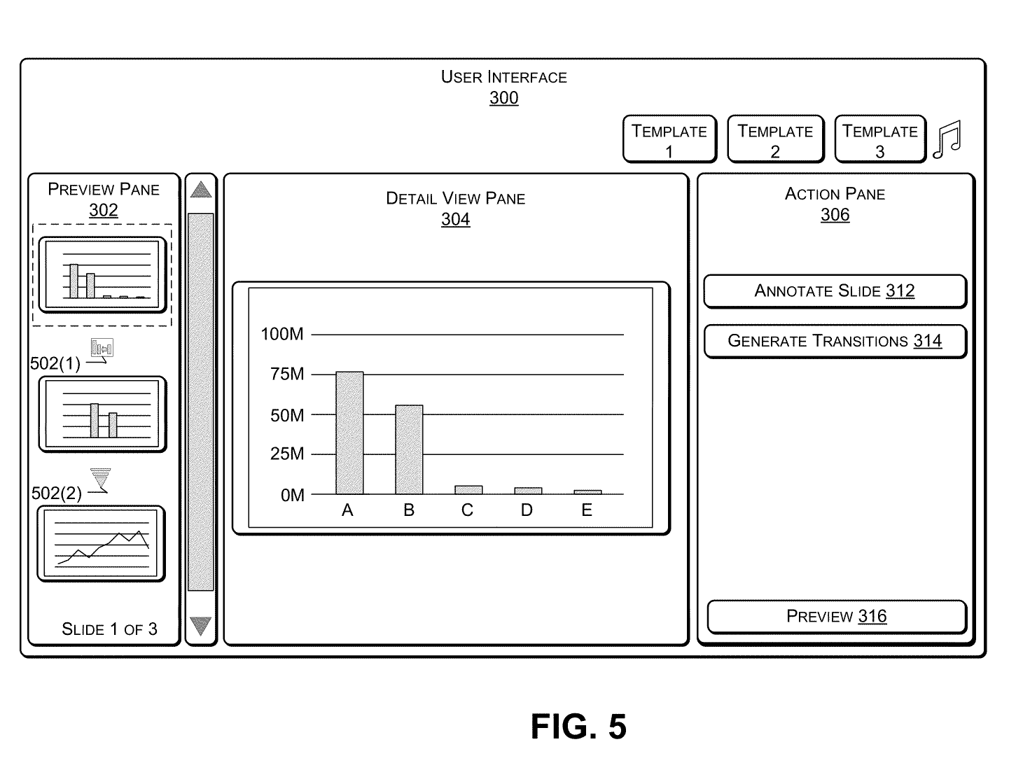

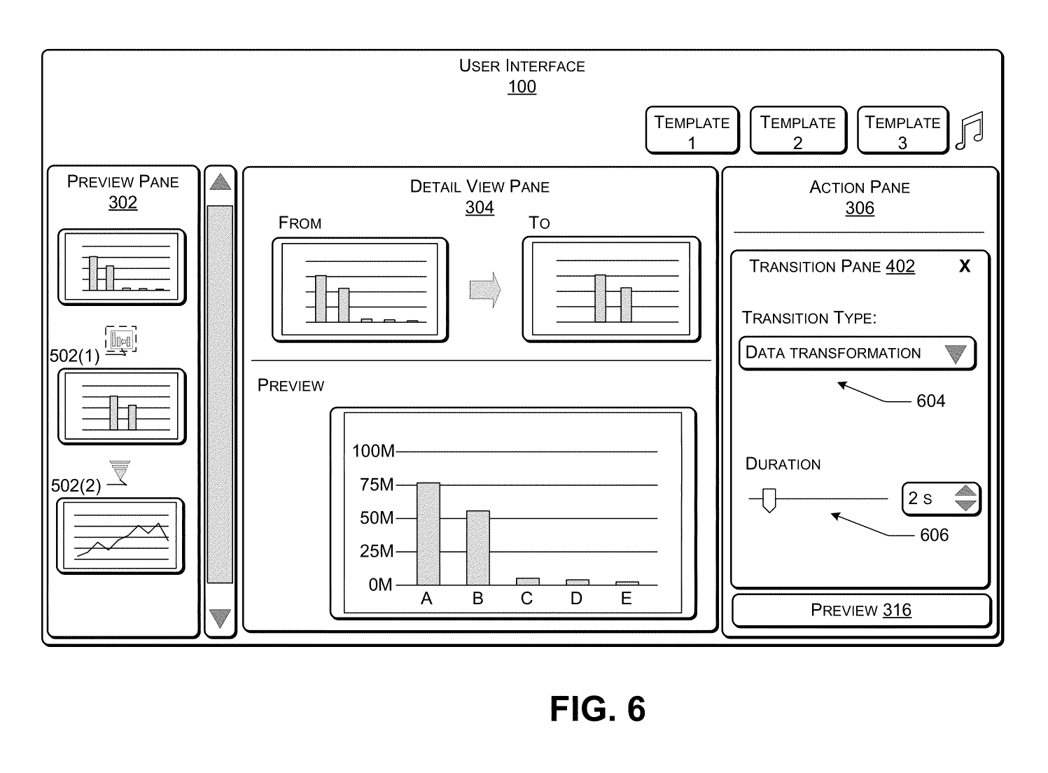

In FIG. 3, the action pane 306 also facilitates user interaction with the slides. For example, the action pane 306 may include one or more of an “annotate slide” selectable icon 312, a “generate transitions” selectable icon 314, and a “preview” selectable icon 316. Selection of the “annotate slide” icon 312 may prompt the user to take actions to include annotations on the slide displayed currently in the detail view pane 304. Examples of slide annotations are discussed below with reference to FIG. 4. Selection of the “generate transitions” icon 314 will generate transitional animations for transitioning between consecutive slides. As discussed above, and as will be detailed further below, the motion data story framework 110 may automatically generate appropriate transitions between slides based on determined semantic differences between consecutive slides. In some implementations, the semantic differences module 216 may discern differences between consecutive slides, and the transitional animation module 218 may, based on those differences, identify a transitional animation. Examples of the interface 300 resulting from user selection of the “generate transitions” icon 314 are discussed below with reference to FIGS. 5 and 6. Selection of the “preview” icon 316 will allow the user to preview the slides 308, such as in a full screen display. In other implementations, selection of the “preview” icon 316 may allow the user to preview a motion data story corresponding to the slides.

Any number of additional or alternative actions may be facilitated via interactive icons in the action pane 306 or elsewhere in the interface 300. For example, FIG. 3 further illustrates one or more template selection icons 318. Selection of one of the template selection icons 318 applies a template to the slides 308. In addition to making fonts, color schemes, backgrounds and the like consistent through all slides 308, templates may also or alternatively include information about animation effects, transitional animations, or other elements, effects, or features to be used in the creation of a motion data story using the slides. As noted above, templates may be used to impart a specific “look and feel” on a motion data story. Templates may be configured to specify transitional animations for certain semantic differences and/or to specify animation effects for use in connection with a single slide. The framework described herein may allow a user to create templates, or templates may be pre-selected and applicable by the user by selecting one of the template selection icons 318.

The user interface 300 also includes an audio icon 320. Selection of the audio icon 320 may facilitate user selection of an audio file, such as for background music, audio effects, or the like. Selection of the audio icon may also allow a user to record audio, such as for a voice over, which may facilitate understanding of a slide, or to otherwise generally narrate the motion data story. In other implementations, a selectable icon that promotes recording audio may be provided in the action pane 306.

Turning now to FIG. 4, an example of a user annotating a slide to provide a richer, more engaging motion data story will be illustrated. FIG. 4 again illustrates the user interface 300, but the user has selected, e.g., by clicking on or drawing a window around in the detail view pane 304, a portion of the slide 308(1). Specifically, the user has selected the first two bars in the illustrated bar graph. Those bars correspond to entities A and B. Having selected the two bars, an annotate slide window 402 has opened in the action pane 306. The annotate slide window may be an expansion of the annotate slide icon 312, or it may be a completely separate window.

As illustrated, the annotate slide window 402 includes a text editor box 404, into which the user may enter text for display on the slide 308(1). Here, because the annotate slide window 402 is opened upon selecting the bars associated with entities A and B, the text may be associated with those selected graphics. In the example, the text added via the text editor box 404 states “A and B dominate the market.” In other implementations, the text entered in the box 404 need not be directly tied to the selected graphics. For instance, the box 404 may be used to enter a title for the entire slide, or to include some other textual context.

In some implementations, however, it may be desirable not only to associate text in the box with the selected graphics, but also to highlight those graphics in some manner. To this end, the annotate slide window 402 also includes an effect editor 406 and a duration editor 408. The effect editor 406 and/or the duration editor 408 allow a user to control attributes of an animation effect that may be used to highlight graphics. For example, the effect editor 406 allows a user to select an animation effect for association with a portion of the graphical representation. In the instance of FIG. 4, an effect called a “jump & shake” effect is associated with the bars corresponding to entities A and B. The “jump & shake” effect creates a visual highlight of the bars by causing them to move vertically off the horizontal axis and shake back and forth, such as by pivoting back and forth about an axis normal to the slide. As will be appreciated, the “jump & shake” effect is one example of any number of animation effects that may be used to highlight a selected portion of the chart to a viewer. For example, FIG. 4 illustrates that the “jump & shake” effect may be included in a drop down menu, and the user may be able to select an alternative effect.

The duration editor 408 allows the user to select how long the animation effect will continue. In the interface 300, the duration may be altered by moving the slider provided as part of the duration editor 406. Although not illustrated, the annotate slide window 402 may include objects to facilitate further control of attributes of the animation effect. For instance, a speed editor may be provided to control a speed of the animation effect. In the example of FIG. 4, the speed editor may be used to control how quickly the selected bars “shake.” The annotate slide window 402 also may include additional information about the selected graphics. For example, the window 402 may include information about the data points, such as a value of the selected data point(s), an identification of the data point(s), and so forth. In some examples, each data point represented in a graph may be listed in the action pane. In these implementations, a user may select one or more data points from the list, rather than select them in the detail view pane, as just described.

Although the example animation effects of FIG. 4 are illustrated and described as being generated as a result of user selection of data points, in other implementations, the animation effects may be automatically generated, based on the determined semantic differences between the slides. As discussed above, the semantic differences module determines differences between consecutive slides. While those differences may be used to determine transitional animations between slides, as discussed in more detail with reference to FIG. 5, the semantic differences also may be used to determine animation effects. For example, the semantic differences module may determine that as between the first slide 308(1) and the second slide 308(2), the bars associated with entities C, D, and E will go away and the bars associated with entities A and B will continue onto the next slide. In some implementations, the framework may also apply an animation effect based on the semantic difference. For example, the framework 110 may automatically apply an animation effect, such as the “jump & shake” animation effect, to the portion of the graph that will survive to the next slide. Such an implementation may further reduce user interaction to create compelling and informative motion data stories.

FIG. 5 illustrates the interface 300 after a user has selected the “generate transitions” icon 314. A difference between the user interface 300 in FIG. 5 and the user interface 300 in FIG. 3 is the introduction of slide transition icons 502 in the storyline pane 102. A first slide transition icon 502(1) is illustrated between the first slide 308(1) and the second slide 308(2), and a second slide transition icon 502(2) is illustrated between the second slide 308(2) and the third slide 308(3). The slide transition icons 502(1), 502(2) indicate that transitional animations have been applied to the slides, to form a motion data story from the slide deck. As discussed above, in embodiments of this disclosure, transitional animations are selected and applied automatically by investigating semantic differences between slides. Thus, the first slide transition icon 502(1) represents a transitional animation between the first slide 308(1) and the second slide 308(2), and that transitional animation is determined based on semantic differences between the first slide 308(1) and the second slide 308(2). Similarly, the second slide transition icon 502(2) represents a transitional animation between the second slide 308(2) and the third slide 308(3), and that transitional animation is determined based on semantic differences between the second slide 308(2) and the third slide 308(3). In the interface 300 in FIG. 5, selecting the preview icon 316 may display the motion data story to the user, e.g., including the slides and the transitions between those slides.

Attributes of the transitional animations may also be adjusted by the user. For example, FIG. 6 illustrates the user interface 300 after selection of the first slide transition icon 502(1). The detail view pane 304 in FIG. 6 illustrates the animation transition in more detail. Specifically, the detail view pane 304 includes a representation of the two slides between which the transition is occurring (the first slide and the second slide) and a preview showing the transition, perhaps as a video in .gif format, from the first slide to the second slide. In the action pane 306 in FIG. 6, a transition pane 402 allows a user to edit attributes of the transitional animation. For example, a user may select a transition type using a transition type drop down menu 604. As discussed above, in implementations of this disclosure, the transition type is determined based on semantic differences between the slides. Thus, because the transition is between two slides of the same type (both bar graphs) and some of the data points (those associated with entities A and B) are identical while others have been removed (those associated with entities C, D, and E), e.g., a SeriesRemove, the framework assigns a transitional animation, here termed a “data transformation”-type transition. In other instances, as detailed above, the transitional animation will be different. For example, when charts contained on the consecutive slides have different chart types, e.g., as in slides 308(2) and 308(3), the framework will assign a different animation, for example, one associated with a VisualChange classification, which may be have a transition type “chart transformation” or something similar. The transition pane 402 also includes a duration editor 604 to specify duration of the transition.

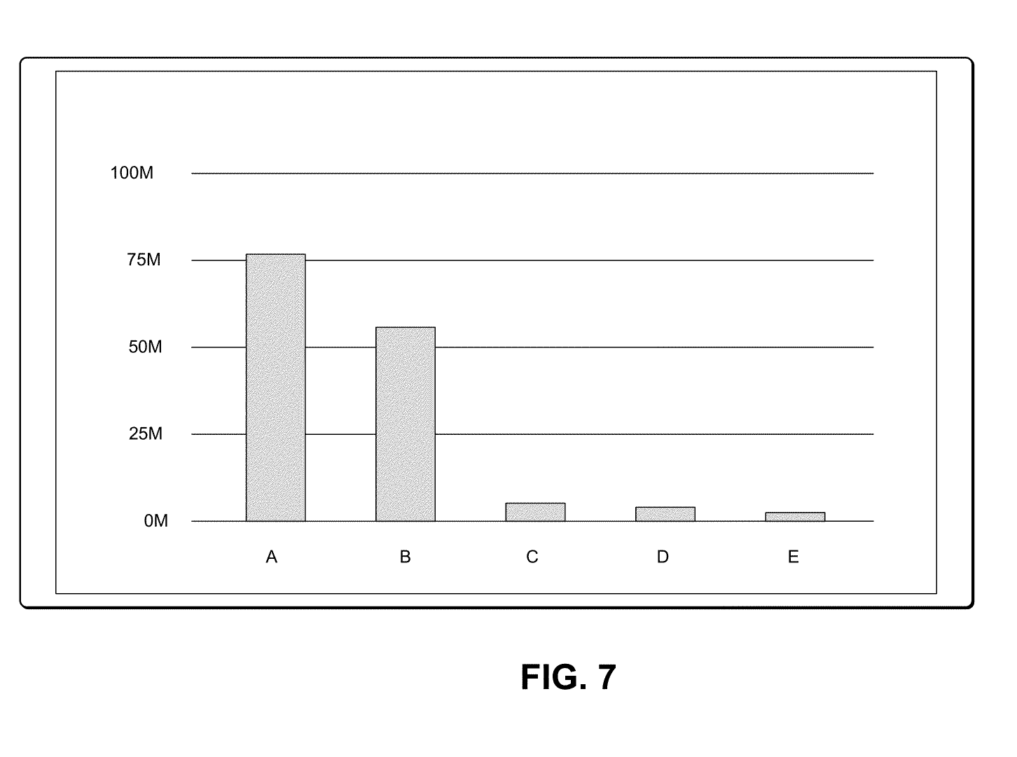

FIGS. 7-10 illustrate ordered (although not consecutive) frames in a motion data story created from the first and second slides 308(1), 308(2) and the transition illustrated in FIG. 6. FIGS. 7-10 may be part of a preview of the motion data story, e.g., upon user selection of the preview icon 316, or part of a final motion data story, e.g., as viewed by the intended audience.

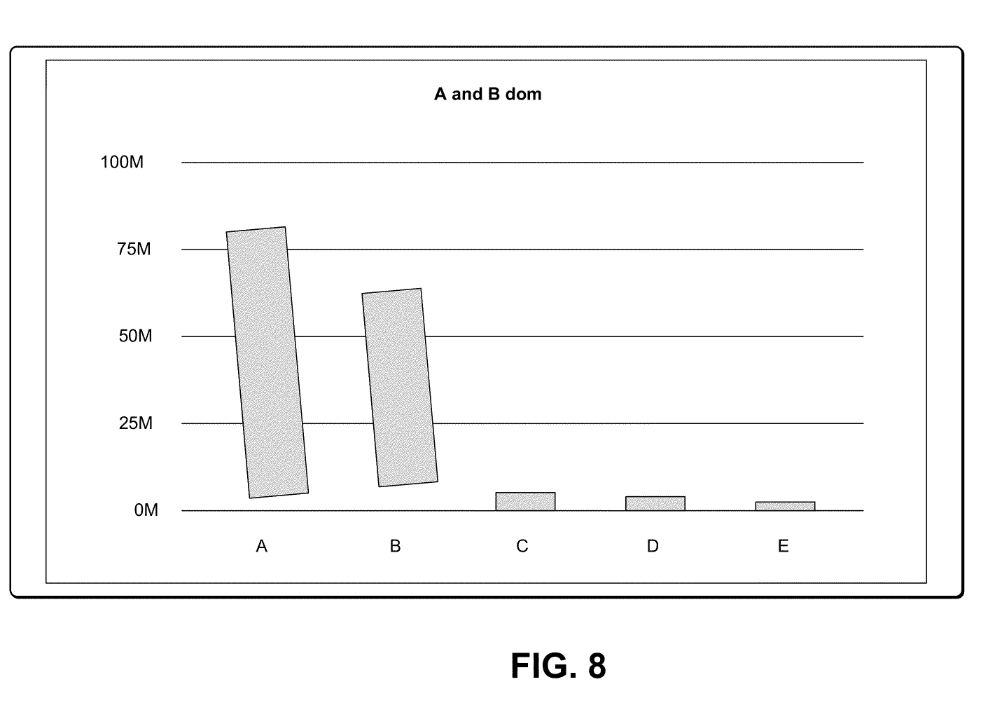

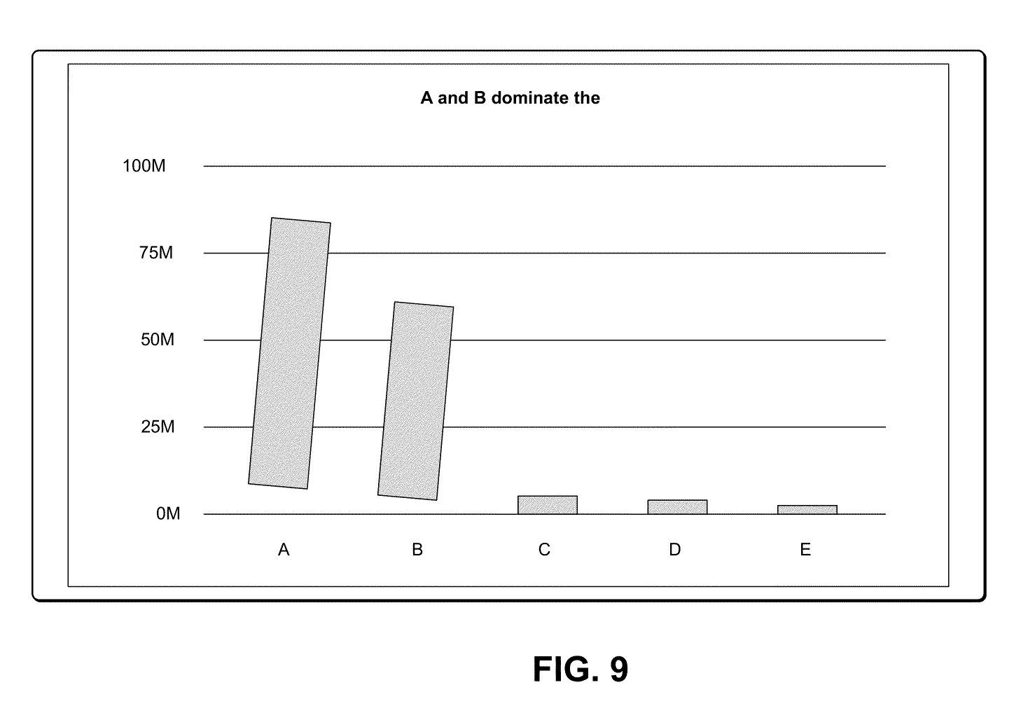

In FIG. 7, the first slide 308(1) is displayed. In FIG. 8, time has elapsed, and the annotation entered via the user interface 300 in FIG. 4 has commenced. Specifically, the textual annotation “A and B dominate the market” has begun to appear on the slide, and the “jump & shake” animation effect has begun. More specifically regarding the latter, the bars associated with entities A and B have moved vertically and begun to pivot in a counter-clockwise direction. In FIG. 9, more time has elapsed, more of the textual annotation has appeared, and the pivoting of the bars has continued, with the bars now being pivoted in a clockwise direction, relative to the original vertical orientation. Thus, the annotation with accompanying animation effect continues.

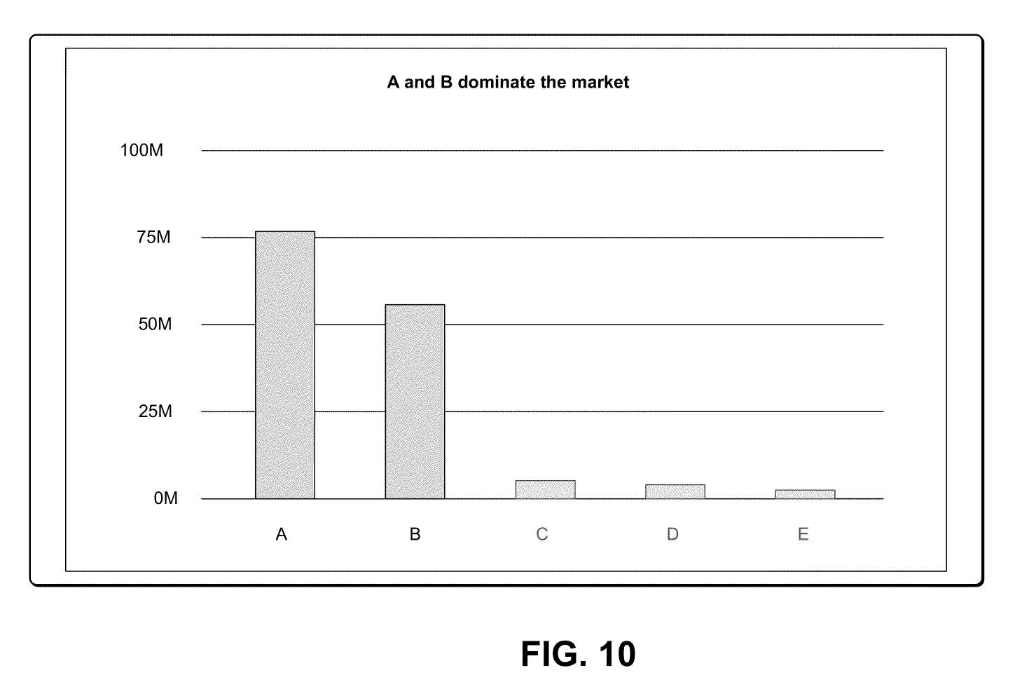

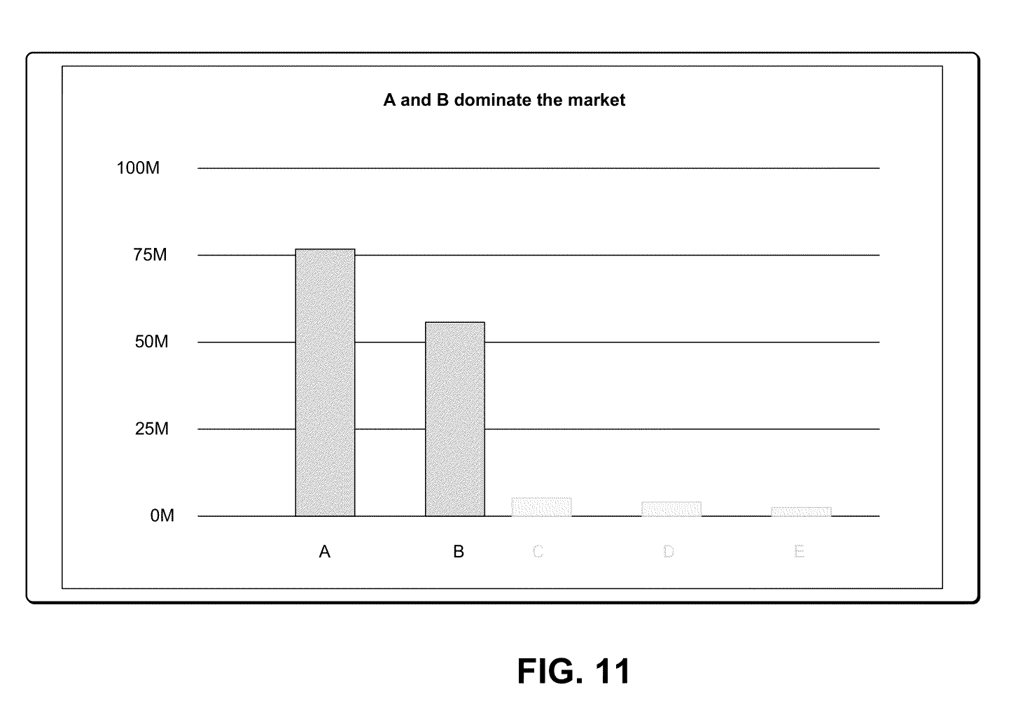

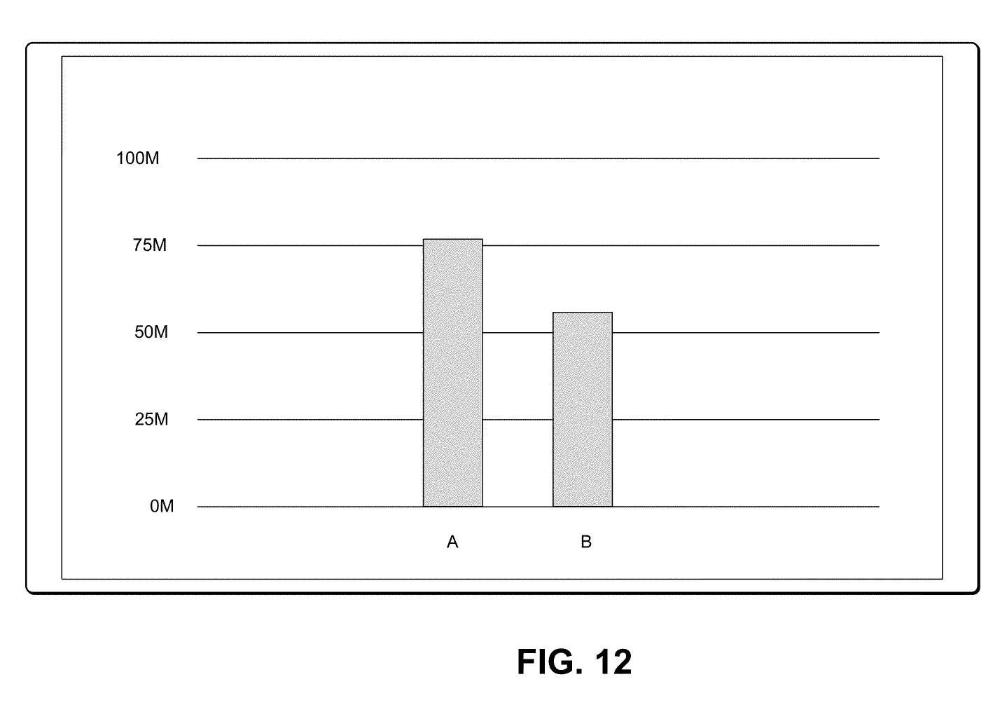

In FIG. 10, the “jump & shake” effect has concluded, with the bars returning to their original position on the X-axis. Also in FIG. 10, the transitional animation has commenced, with the bars representing entities C, D, and E beginning to fade away. In FIG. 11, the animation continues with the bars representing entities C, D, and E fading away further, and the bars representing entities A and B moving along the x-axis, in a direction away from the y-axis. In FIG. 12, the bars representing entities C, D, and E are gone, and the bars representing entities A and B are centered. FIG. 12 is the second slide 308(2).

As will be appreciated, the abruptness of a conventional slide show is replaced with a smooth transition between slides. Moreover, the animation effect cues the reader to understand that A and B are the most significant players in the market (via the “jump & shake” animation effect and the annotation text), and furthers that understanding by fading out all other competitors (via the transitional animation).

The illustration of FIGS. 7 and 10 is only an example. For instance, the animation effect, i.e., the “jump & shake” effect may overlap with the transitional animation, i.e., the fading away of entities C, D, and E and centering of entities A and B, instead of the transitional animation commencing after completion of the animation effect. The start and/or stop times of the effects may also be controllable attributes of the animation effect and/or transitional animation. Moreover, as illustrated by the drop down menu 604, other transitional animations may be applied. In some embodiments, the transitional animation module 218 may determine that two or more transitional animations could serve as effective transitions, and some or all of those animations could be included in the drop down menu 604.

As should also be appreciated, semantic differences will vary among consecutive pairs of slides, and thus the transitional animations may be quite different. For example, although not illustrated, transitional animations applicable to the transition from the second slide 308(2) to the third slide 308(3) (“a second transition”) will be quite different from those applicable to the transition illustrated in FIGS. 7-10 (“the first transition”). Of note, the second transition must transition from a bar chart to a line chart. Moving bars on a horizontal axis as in the first transition will not transition the bars to a line chart. Instead, a transitional animation that zooms in on the bar that is to be described in more detail by the line graph and subsequently morphs into the line chart may better convey the transition between slides to the intended audience. More specifically, in the illustrated embodiment, the line graph of the third slide 308(3) may indicate sales data for entity A over some time period. Thus, data relative to entity B is not included in the third slide 308(3). By specifically keying the transitional animation to the bar associated with entity A, a better visualization may be achieved. In one example, the bar associated with entity B may fade away, much like the bars associated with entities C, D, and E faded away in transitioning from the first slide 308(1) to the second slide 308(2), leaving only the bar associated with entity A. Then, the animation may zoom in on the remaining bar and fade to the line graph. The fading out of the bar associated with entity B may not be required, however, as the transitional animation may focus on the bar associated with entity A, such as by tying the zoom to that bar only, instead of a generic zoom, e.g., from a center or other arbitrary point. In other embodiments, an animation effect, like the “jump & shake” effect, for example, may be applied to the bar associated with entity A, to draw the audience's attention to entity A before transitioning to the line chart. In still other implementations, additional content, such as an audio cue, may be used to smooth the transition for the audience.

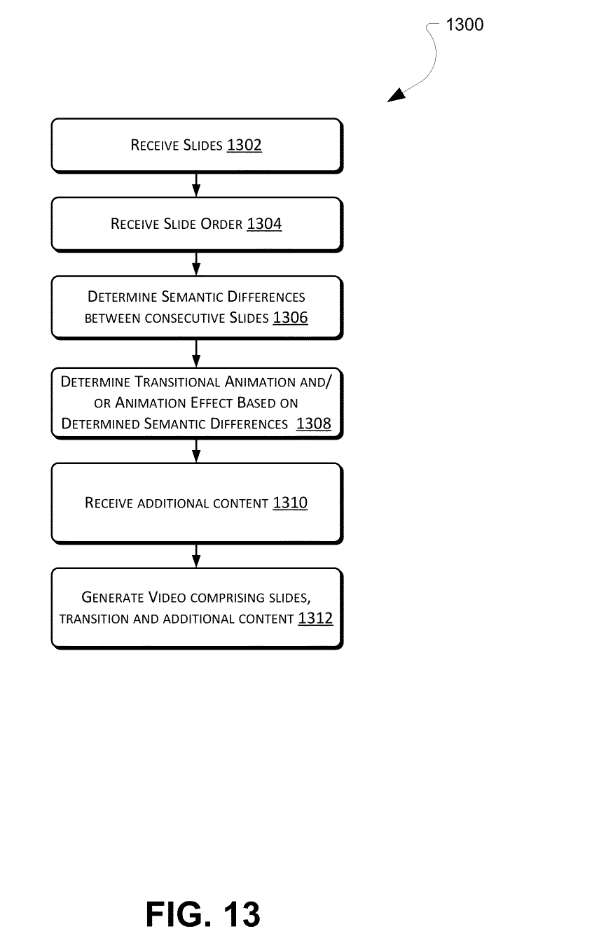

FIG. 13 illustrates an example process flow 1300 according to an implementation of this disclosure. In the flow diagram of FIG. 13, each block represents one or more operations that can be implemented in hardware, software, or a combination thereof. In the context of software, the blocks represent computer executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. Numerous other variations will be apparent to those of skill in the art in light of the disclosure herein. For discussion purposes, the process flow in FIG. 13 is described with reference to FIGS. 1-12, described above, although other models, frameworks, systems and environments may implement the illustrated process.

Referring to FIG. 13, at block 1302, the process flow 1300 includes receiving a plurality of slides. The slides may be created via the interface applying the motion data story framework, or may be imported from some different program or application.

At block 1304, the process flow 1300 receives a slide order. As noted above, the user may re-order slides using the interface 300. By selecting the slides and the order for the slides, the user acts as an author to define what information is to be conveyed by the motion data story, and in what order that information will be conveyed.

At block 1306, the process flow 1300 determines semantic differences between consecutive slides. The semantic differences can include any differences in any measurable or otherwise identifiable feature or attribute of the graphical depictions of the consecutive slides or data represented by the graphical depiction. To facilitate determination of the semantic differences, the process flow 1300 may access chart models that include information about each of the graphical representations. The models may include data values, measures, categories, as well as coordinates of data points in the graphical representations, and so forth. The determined semantic differences may be characterized as a type of semantic difference, as discussed in some detail above.

At block 1308, the process flow 1300 determines a transitional animation and/or an animation effect based on the determined semantic differences. In some implementations, a type of semantic difference, such as addition of a series of data, may correspond to one or more types of transitional animations and/or animation effects. More specifically, there may be multiple ways to visually convey the addition of a new series of data to an existing chart. When more than one transitional animations and/or animation effects may be possible, the process flow 1300 may select among the possibilities based on some criteria. In some instances, the process flow 1300 may also present each of the possible transitional animations and/or animation effects for user selection, such as in a drop down menu or the like. The process flow 1300 may also receive an indication of a specified template, and the template may help to instruct selection of an appropriate transitional animation and/or animation effect.

At block 1310, the process flow 1300 may receive additional content, for example, via user interaction with an interface. Among other things, the additional content may include annotations, such as textual annotations; animation effects, like the “jump & shake” effect used in earlier examples; or audio content, which may be a voice-over recorded in conjunction with displaying the slides and/or an imported audio clip.

At block 1312, the process flow 1312 includes generating a video, as a motion data story, that includes the slides, transitional animations between slides and the additional content.

The process flow 1300 is merely an example process flow. In other examples, the operations/blocks may be rearranged, combined modified, or omitted without departing from the disclosure.

In summary, example embodiments of the present disclosure provide a framework, including devices and methods, for generating motion data stories as a means for communicating data to an audience. The framework facilitates generation of such motion data stories by identifying semantic differences between consecutive slides and using those semantic differences to determine a transitional animation useful for transitioning between the consecutive slides. The result is a motion data story that may exhibit a more pleasing and/or informative transition between those slides. The framework may also allow for incorporation of additional content, such as animation effects, audio, text, and/or other content, allowing a user to quickly, artfully, and with little effort create a motion data story. The framework also provides tools to modify a generated motion data story. In some aspects, the framework results in an easier user experience to create quality motion data stories. The methods described herein may minimize user input, by automatically identifying semantic differences between consecutive slides and determining transitional animations and/or animation effects based on those differences. As a result, such methods enable the user to generate pleasing, engaging, and informative motion data stories relatively quickly, thereby facilitating the use of such motion data stories as an efficient means of communicating data.

### Further Examples

A: A computer-implemented system for creating a video from a plurality of slides comprising: one or more processors; computer-readable media storing instructions that, when executed by the one or more processors, cause the one or more processors to perform one or more acts comprising: determining a semantic difference between a first slide and a second slide of a plurality of slides, wherein the first slide and the second slide are consecutive slides, the first slide comprises a first graphical depiction, and the second slide comprises a second graphical depiction; determining automatically, based at least in part on the semantic difference between the first slide and the second slide, an animation effect for use in the first slide or the second slide; and generating a video comprising the animation effect in conjunction with the respective first slide or the second slide.

B: A system as paragraph A recites, wherein the instructions, when executed by the one or more processors, cause the one or more processors to perform further acts comprising presenting, via a user interface, the first slide, the second slide, and one or more animation effect attributes associated with the animation effect.

C: A system as paragraph A or paragraph B recites, wherein the animation effect attributes include one or more of duration of the animation effect and a speed of the animation effect.

D: A system as any of paragraphs A-C recites, further comprising receiving, via the user interface, a selection of the animation effect from a plurality of animation effects.

E: A system as any of paragraphs A-D recites, wherein the instructions, when executed by the one or more processors, cause the one or more processors to perform further acts comprising automatically determining, based at least in part on the semantic difference between the first slide and the second slide, a transitional animation for transitioning between the first slide and the second slide, and wherein there generating the video further comprises the transitional animation transitioning between the first slide and the second slide.

F: A system as any of paragraphs A-E recites, wherein the determining the transitional animation comprises determining a plurality of transitional animations and selecting the transitional animation from the plurality of transitional animations.

G: A system as any of paragraphs A-F recites, further comprising presenting, via the user interface, one or more transitional animation attributes associated with the transitional animation.

H: A system as any of paragraphs A-G recites, wherein the one or more transitional animation effects include one or more of duration of the transitional animation and a speed of the transitional animation.

I: A system as any of paragraphs A-H recites, wherein the instructions, when executed by the one or more processors, cause the one or more processors to perform further acts comprising: presenting, via a user interface, the first slide or the second slide; and receiving, via the user interface, a selection of a template for use in the video, wherein the animation effect is determined at least in part based on the template and the creating the video includes applying the template to the first slide and the second slide.

J: A method of creating a video from a plurality of slides comprising: under control of one or more processors, receiving a first slide comprising a first graphical depiction, the first graphical depiction depicting a first plurality of data; receiving a second slide comprising a second graphical depiction, the second graphical depiction depicting a second plurality of data; determining a semantic difference between at least one of (i) the first graphical depiction and the second graphical depiction or (ii) the first plurality of data and the second plurality of data; determining automatically, based at least in part on the semantic difference, a transitional animation for transitioning between the first slide and the second slide; and creating a video including the transitional animation transitioning between the first slide and the second slide.

K: A method as paragraph J recites, wherein the determining the semantic difference comprises comparing at least one of a value or a graphical depiction of each of the first plurality of data to a corresponding at least one of a value or a graphical depiction of each of the second plurality of data.

L: A method as either paragraph J or K recites, further comprising: presenting, via a user interface, the first slide; receiving, via the user interface and at least in part in response to presenting the first slide, a user selection of a portion of the first graphical depiction depicting one or more of the first plurality of data points; and associating an animation effect with the portion of the first graphical depiction, wherein the creating the video includes applying the animation effect to the portion of the first graphical depiction.

M: A method as any of paragraphs J-L recites, further comprising receiving, via the user interface, a user selection of a first slide template or a second slide template, wherein the determining the transitional animation is based at least in part on the selection of the first slide template or the second slide template.

N: A method as any of paragraphs J-M recites, wherein the transitional animation is one of a plurality of transitional animations, the semantic difference corresponds to one of a plurality of semantic difference types, and each of the plurality of transitional animations is associated with at least one of the plurality of semantic difference types.

O: A method as any of paragraphs J-N recites, wherein the determining the transitional animation comprises selecting one of the plurality of transitional animations associated with the semantic difference type to which the semantic difference corresponds.

P: A computer readable medium having computer-executable instructions thereon, the computer-executable instructions to configure a computer to perform a method as any of paragraphs J-O recites.

Q: A computer-implemented method of generating a video from a plurality of still slides, the method comprising: presenting, via a user interface, a first slide and a second slide, the first slide including a first graphical depiction of a plurality of data points and the second slide including a second graphical depiction of a plurality of data points; receiving, via the user interface, an indication of a template; determining one or more semantic differences between the first slide and the second slide; and determining, based at least in part on the one or more semantic differences and the template, a transitional animation for transitioning between the first slide and the second slide; and generating a video comprising the transitional animation transitioning between the first slide and the second slide.

R: A method as in paragraph Q, wherein the determining the transitional animation comprises determining a plurality of transitional animations for transitioning between the first slide and the second slide, the method further comprising: presenting, via the user interface, a plurality of transitional animations for transitioning between the first slide and the second slide, including the transitional animation; and receiving, via the user interface, a user selection of the transitional animation.

S: A method of paragraph Q or paragraph R, further comprising receiving, via the user interface, a selection of an icon representing the transitional animation; and presenting, at least in part in response to the selection of the representation of the transitional animation, a transitional animation editing pane.

T: A method of any of paragraphs Q-S, further comprising: presenting, in the transitional animation editing pane, a transitional animation attribute; and receiving, via the user interface, a change of the transitional animation attribute.

U: A method of any of paragraphs Q-T, further comprising: receiving, via the user interface, a selection of the first slide; and presenting, on the user interface, an editing pane; and receiving, via user interaction with the editing pane, content for association with the first slide, wherein the generating the video further comprises including the content for association with the first slide.

V: A computer readable medium having computer-executable instructions thereon, the computer-executable instructions to configure a computer to perform a method as any of paragraphs Q-U recites.

### CONCLUSION

Although the techniques have been described in language specific to structural features and/or methodological acts, it is to be understood that the appended claims are not necessarily limited to the features or acts described. Rather, the features and acts are described as example implementations of such techniques.

The operations of the example processes are illustrated in individual blocks and summarized with reference to those blocks. The processes are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) 106, 120, 200, and/or 300 such as one or more internal or external CPUs or GPUs, and/or one or more pieces of hardware logic such as FPGAs, DSPs, or other types of accelerators.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, is understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

What is claimed is:

1. A computer-implemented system for creating a video from a plurality of slides comprising:
one or more processors;
memory storing instructions that, when executed by the one or more processors, cause the one or more processors to perform one or more acts comprising:
determining a semantic difference between a first slide and a second slide of a plurality of slides, wherein the first slide and the second slide are consecutive slides, the first slide comprises a first graphical depiction, and the second slide comprises a second graphical depiction;
determining automatically, based at least in part on the semantic difference between the first slide and the second slide, an animation effect for use in the first slide or the second slide; and
generating a video comprising the animation effect in conjunction with the respective first slide or the second slide.

2. The system of claim 1, wherein the instructions, when executed by the one or more processors, cause the one or more processors to perform further acts comprising presenting, via a user interface, the first slide, the second slide, and one or more animation effect attributes associated with the animation effect.

3. The system of claim 2, wherein the animation effect attributes include one or more of duration of the animation effect and a speed of the animation effect.

4. The system of claim 3, receiving, via the user interface, a selection of the animation effect from a plurality of animation effects.

5. The system of claim 1, wherein the instructions, when executed by the one or more processors, cause the one or more processors to perform further acts comprising automatically determining, based at least in part on the semantic difference between the first slide and the second slide, a transitional animation for transitioning between the first slide and the second slide, and wherein there generating the video further comprises the transitional animation transitioning between the first slide and the second slide.

6. The system of claim 5, wherein the determining the transitional animation comprises determining a plurality of transitional animations and selecting the transitional animation from the plurality of transitional animations.

7. The system of claim 5, further comprising presenting, via the user interface, one or more transitional animation attributes associated with the transitional animation.

8. The system of claim 7, wherein the one or more transitional animation effects include one or more of duration of the transitional animation and a speed of the transitional animation.

9. The system of claim 8 wherein the instructions, when executed by the one or more processors, cause the one or more processors to perform further acts comprising:
presenting, via a user interface, the first slide or the second slide; and
receiving, via the user interface, a selection of a template for use in the video,
wherein the animation effect is determined at least in part based on the template and the creating the video includes applying the template to the first slide and the second slide.

10. A method of creating a video from a plurality of slides comprising:
under control of one or more processors,
receiving a first slide comprising a first graphical depiction, the first graphical depiction depicting a first plurality of data;
receiving a second slide comprising a second graphical depiction, the second graphical depiction depicting a second plurality of data;
determining a semantic difference between at least one of (i) the first graphical depiction and the second graphical depiction or (ii) the first plurality of data and the second plurality of data;
determining automatically, based at least in part on the semantic difference, a transitional animation for transitioning between the first slide and the second slide; and
creating a video including the transitional animation transitioning between the first slide and the second slide.

11. The method of claim 10, wherein the determining the semantic difference comprises comparing at least one of a value or a graphical depiction of each of the first plurality of data to a corresponding at least one of a value or a graphical depiction of each of the second plurality of data.

12. The method of claim 10, further comprising:
presenting, via a user interface, the first slide;
receiving, via the user interface and at least in part in response to presenting the first slide, a user selection of a portion of the first graphical depiction depicting one or more of the first plurality of data points; and
associating an animation effect with the portion of the first graphical depiction,
wherein the creating the video includes applying the animation effect to the portion of the first graphical depiction.

13. The method of claim 10, further comprising receiving, via the user interface, a user selection of a first slide template or a second slide template, wherein the determining the transitional animation is based at least in part on the selection of the first slide template or the second slide template.

14. The method of claim 10, wherein the transitional animation is one of a plurality of transitional animations, the semantic difference corresponds to one of a plurality of semantic difference types, and each of the plurality of transitional animations is associated with at least one of the plurality of semantic difference types.

15. The method of claim 14, wherein the determining the transitional animation comprises selecting one of the plurality of transitional animations associated with the semantic difference type to which the semantic difference corresponds.

16. A computer-implemented method of generating a video from a plurality of still slides, the method comprising:
presenting, via a user interface, a first slide and a second slide, the first slide including a first graphical depiction of a plurality of data points and the second slide including a second graphical depiction of a plurality of data points;
receiving, via the user interface, an indication of a template;
determining one or more semantic differences between the first slide and the second slide; and
determining, based at least in part on the one or more semantic differences and the template, a transitional animation for transitioning between the first slide and the second slide; and
generating a video comprising the transitional animation transitioning between the first slide and the second slide.

17. The method of claim 16, wherein the determining the transitional animation comprises determining a plurality of transitional animations for transitioning between the first slide and the second slide, the method further comprising:
presenting, via the user interface, a plurality of transitional animations for transitioning between the first slide and the second slide, including the transitional animation; and
receiving, via the user interface, a user selection of the transitional animation.

18. The method of claim 16, further comprising:
receiving, via the user interface, a selection of an icon representing the transitional animation; and
presenting, at least in part in response to the selection of the representation of the transitional animation, a transitional animation editing pane.

19. The method of claim 18, further comprising:
presenting, in the transitional animation editing pane, a transitional animation attribute; and
receiving, via the user interface, a change of the transitional animation attribute.

20. The method of claim 16, further comprising:
receiving, via the user interface, a selection of the first slide; and
presenting, on the user interface, an editing pane; and
receiving, via user interaction with the editing pane, content for association with the first slide,
wherein the generating the video further comprises including the content for association with the first slide.
